(19) United States
(12) Patent Application Publication
(10) Pub. No.: US 2023/0152465 A1
(43) Pub. Date: May 18, 2023

(54) UNSUPERVISED DOMAIN ADAPTATION FOR LiDAR SEGMENTATION VIA ENHANCED PSEUDO-LABELING TECHNIQUES

(71) Applicant: Motional AD LLC, Boston, MA (US)

(72) Inventors: Lingdong Kong, Singapore (SG); Venice Erin Baylon Liong, Singapore (SG); Niamul Quader, Toa Payoh (SG)

(21) Appl. No.: 17/590,920

(22) Filed: Feb. 2, 2022

Related U.S. Application Data
(60) Provisional application No. 63/279,523, filed on Nov. 15, 2021.

(51) Int. Cl. G01S 17/931; G06T 7/143; G01S 7/491; G06N 3/08

(52) U.S. Cl. CPC G01S 17/931; G06T 7/143; G01S 7/491; G06N 3/088; G06T 2207/20081

(57) ABSTRACT

Provided are methods for unsupervised domain adaptation for LiDAR segmentation via enhanced pseudo-labelling techniques, which can include training a machine learning model to perform a segmentation task for a source domain using a first sample set. Some methods also include generating a second sample set by applying the trained model to one or more unannotated samples associated with a target domain, and annotating the one or more unannotated samples with one or more pseudo-labels corresponding to an output of the trained machine learning model. Some methods also include generating a third sample set that includes at least one sample formed by concatenating a first sample from the first sample set and a second sample from the second sample set with target inputs. Some methods also include updating the trained machine learning model to perform the segmentation task for the target domain. Systems and computer program products are also provided.

### CROSS REFERENCE TO RELATED APPLICATIONS

This application claims the benefit of and priority to U.S. Provisional Patent Application Ser. No. 63/279,523, filed on Nov. 15, 2021, and entitled “UNSUPERVISED DOMAIN ADAPTATION FOR LiDAR SEGMENTATION VIA ENHANCED PSEUDO-LABELING TECHNIQUES,” the entirety of which is incorporated by reference.

### BACKGROUND

An autonomous vehicle may be capable of sensing its surrounding environment and navigating with minimal to no human input. In order to safely traverse a selected path while avoiding obstacles that may be present along the way, the vehicle may rely on various types of sensor data. For example, light detection and ranging (LiDAR) sensor data may include three-dimensional data in the form of point clouds. The sensor data may be annotated with semantic labels that enable the vehicle to distinguish between different physical features present in the vehicle's surrounding environment. However, annotating sensor data, particularly three-dimensional sensor data such as LiDAR sensor data, to include accurate and consistent semantic labels can be an expensive and resource-intensive task.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIG. 5 is a diagram of an implementation of a process for unsupervised domain adaptation for LiDAR segmentation via enhanced pseudo-labeling techniques;

FIG. 6 is a diagram of an implementation of a process for unsupervised domain adaptation for LiDAR segmentation via enhanced pseudo-labeling techniques;

FIG. 7 is a diagram of an overview of enhanced pseudo-labeling techniques for use in unsupervised domain adaptation for LiDAR segmentation;

FIG. 8 is a diagram of an implementation of a process for enhanced pseudo-labeling techniques for use in unsupervised domain adaptation for LiDAR segmentation;

FIG. 9 is a diagram of an overview of entropy ranking techniques used in pseudo-label generation applied to unsupervised domain adaptation for LiDAR segmentation;

FIG. 10 is a diagram of an implementation of a process for entropy ranking techniques used in pseudo-label generation applied to unsupervised domain adaptation for LiDAR segmentation;

FIG. 11 is a diagram of domain concatenation data used in unsupervised domain adaptation for LiDAR segmentation via enhanced pseudo-labeling techniques;

FIG. 12 is a diagram of domain concatenation strategies used in unsupervised domain adaptation for LiDAR segmentation via enhanced pseudo-labeling techniques;

FIG. 13 is a flowchart of a process for unsupervised domain adaptation for LiDAR segmentation via enhanced pseudo-labeling techniques; and

FIG. 14 is a flowchart of a process for unsupervised domain adaptation for LiDAR segmentation using source data concatenation based on confidence determination techniques.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

A vehicle (e.g., an autonomous vehicle) includes sensors that monitor various parameters associated with the vehicle. For example, some sensors, such as cameras and LiDAR sensors, detect the presence of objects, such as other vehicles, pedestrians, street lights, landmarks, and drivable surfaces, in the vehicle's environment. Each sensor transmits gathered data to the vehicle's monitor and/or control system(s). Using data received from a combination of the sensors, the control system(s) may predict labels for the detected objects, which can be used to generate or update maps of the vehicle's environment. For example, images from the cameras can be enhanced and used in combination with raw data recorded from the LiDAR sensors to predict semantic labels for use in map generation.

In some aspects and/or embodiments, systems, methods, and computer program products described herein include and/or implement techniques for training a machine learning model, such as a neural network, to perform a segmentation task associated with a source domain. The training can utilize a data set of LiDAR segmentation data that has been annotated with ground-truth labels corresponding to the source domain. The training can further apply the machine learning model to LiDAR segmentation data associated with a target domain which excludes ground-truth labels. The LiDAR segmentation data of the target domain can be annotated with pseudo-labels corresponding to an output of the trained machine learning model. A dataset of mixed domain data can be generated to include data samples associated the annotated LiDAR segmentation data of the source domain and data samples associated with the unannotated LiDAR segmentation data of the target domain. The techniques can further include updating the trained machine learning model to perform the segmentation task for the target domain. In this way, machine learning models can be trained to perform domain adaptation for a variety of different domains. For example, the techniques described herein can enable adaptation of machine learning models, without limit, to accurately predict variations based on domain locations, domain environments, domain weather, and domain objects, or any combination thereof.

By virtue of the implementation of systems, methods, and computer program products described herein, techniques for unsupervised domain adaptation for LiDAR segmentation via enhanced pseudo-labeling techniques are provided. Unsupervised domain adaptation may enable a LiDAR segmentation model to be updated for a target domain without ground-truth annotations for samples from the target domain. As such, advantages of unsupervised domain adaptation techniques include faster and less expensive deployment of the LiDAR segmentation model in new domains. Unsupervised domain adaptation techniques described herein may enable enhanced domain differentiation and adaptation performance across a variety of domain discrepancies including, for example, location-to-location adaptation, weather-to-weather adaptation, and day-to-night adaptation. Moreover, when applied to initialize the semantic annotation process, unsupervised domain adaptation techniques may improve the corresponding segmentation results.

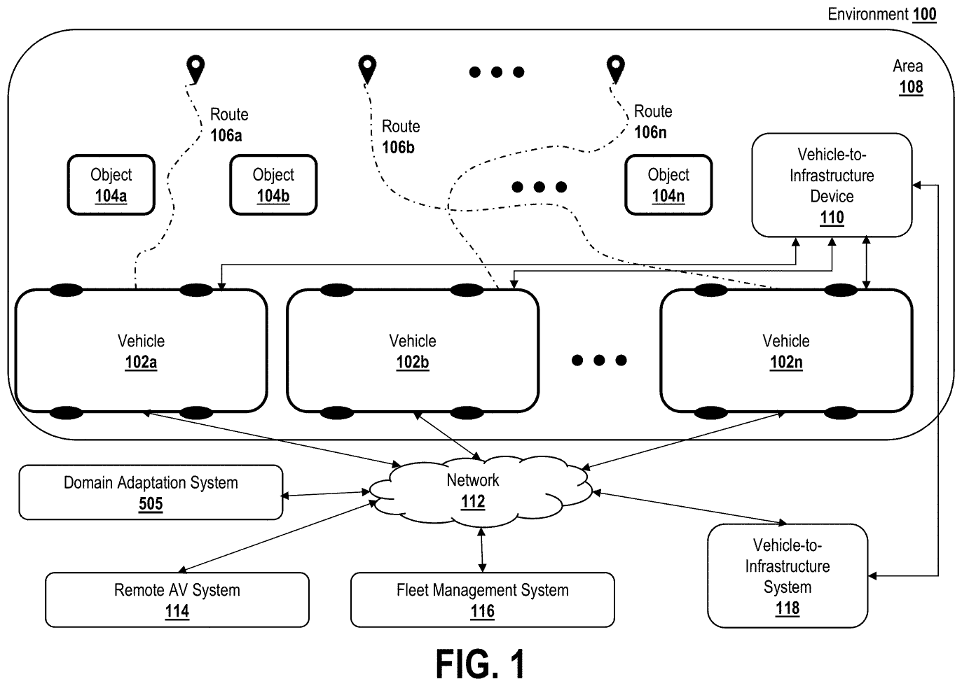

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

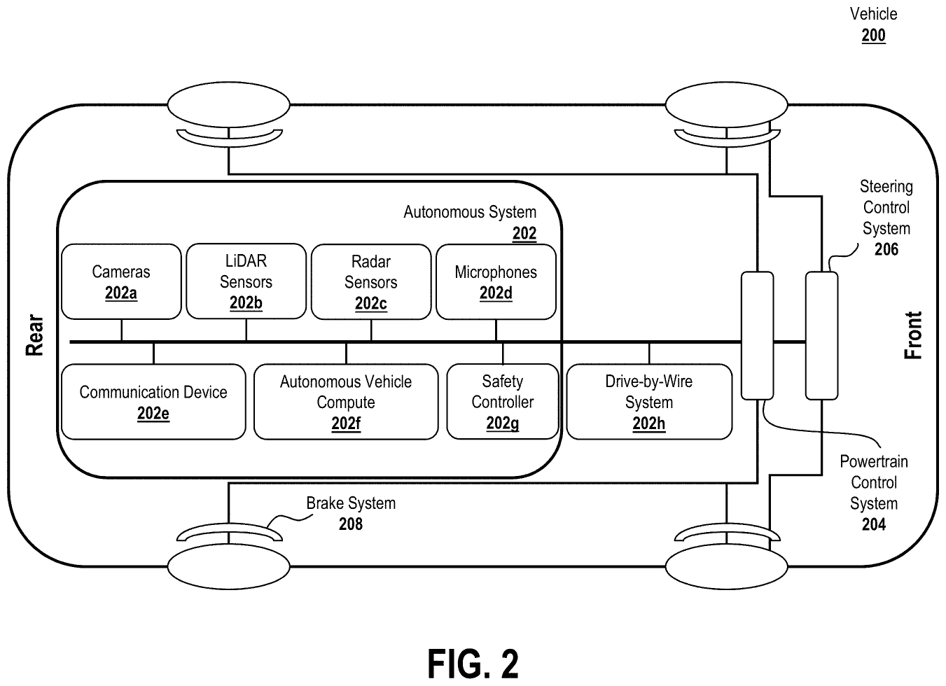

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

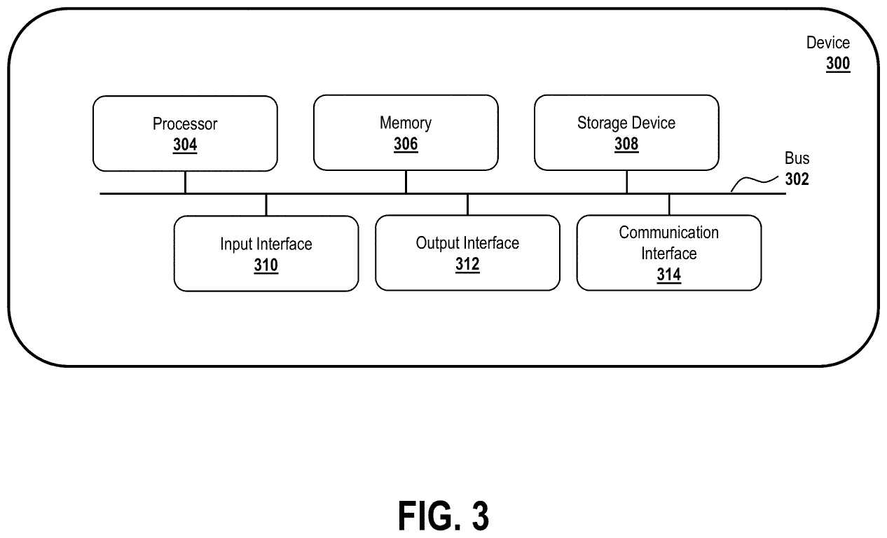

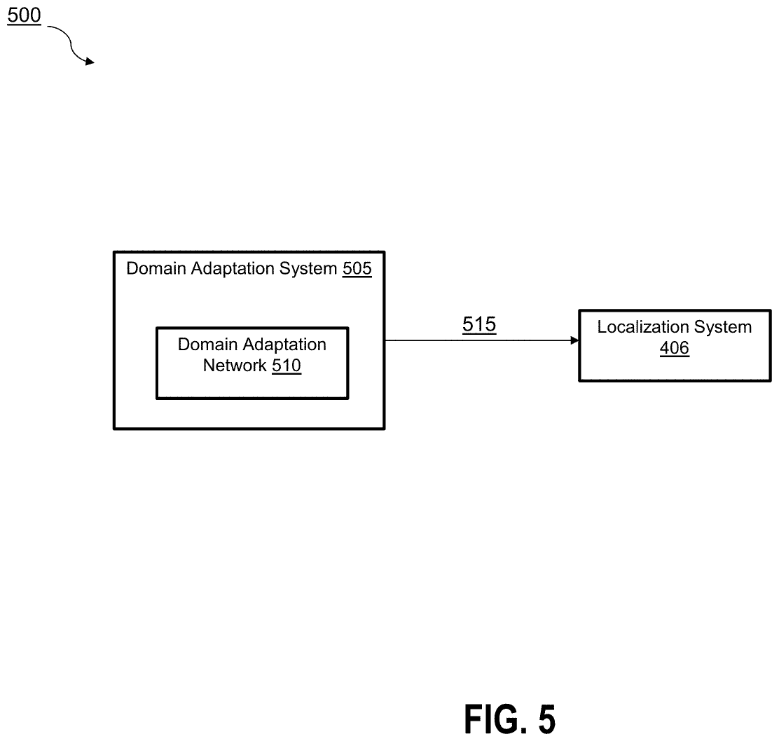

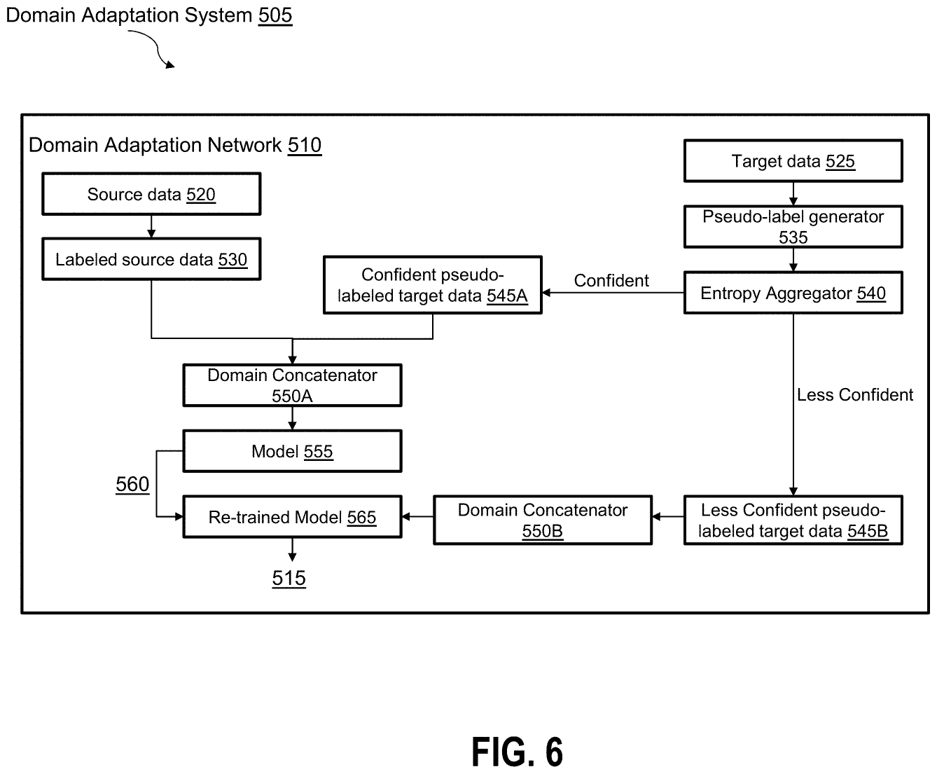

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f, a domain adaptation system 505 (e.g., an unsupervised domain adaptation system configured to perform LiDAR segmentation via enhanced pseudo-labeling techniques as or similar to the domain adaptation system 505 of FIGS. 5-6), and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, safety controller 202g, and/or domain adaptation system 505 via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of domain adaptation system 505, and/or one or more devices of network 112 (e.g., one or more devices of a system of network 112). In some embodiments, one or more devices of vehicles 102 (e.g., one or more devices of a system of vehicles 102), domain adaptation system 505, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

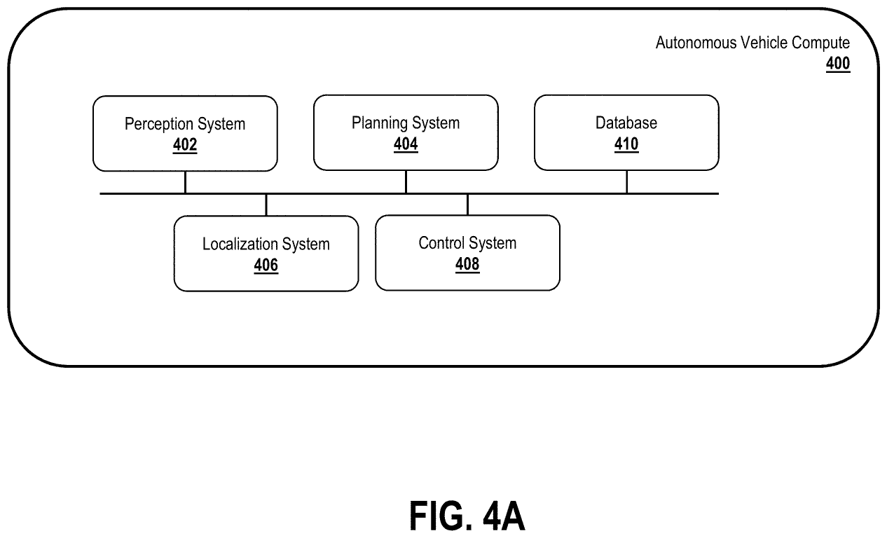

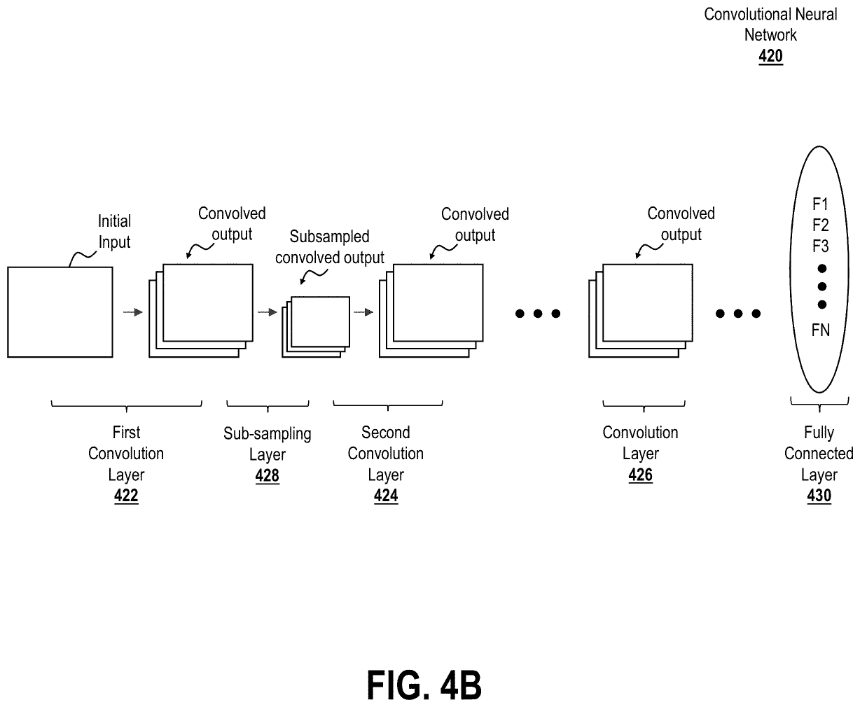

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, control system 408, and/or domain adaptation system 505 (see FIGS. 5-6) implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, control system 408, and/or domain adaptation system 505 implement at least one machine learning model alone or in combination with one or more of the above-noted systems. In some examples, perception system 402, planning system 404, localization system 406, control system 408, and/or domain adaptation system 505 implement at least one machine learning model as part of a pipeline (e.g., a pipeline for identifying one or more objects located in an environment and/or the like). An example of an implementation of a machine learning model is included below with respect to FIG. 4B.

Database 410 stores data that is transmitted to, received from, and/or updated by perception system 402, planning system 404, localization system 406, control system 408, and/or domain adaptation system 505. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, control system 408, and/or domain adaptation system 505. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function, CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like).

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 420 normalizing sensor data (e.g., image data, LiDAR data, radar data, and/or the like).

In some embodiments, CNN 420 generates an output based on perception system 420 performing convolution operations associated with each convolution layer. In some examples, CNN 420 generates an output based on perception system 420 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 420 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 5-12, illustrated are diagrams of an implementation 500 for unsupervised domain adaptation for LiDAR segmentation via enhanced pseudo-labeling techniques. In some embodiments, implementation 500 includes domain adaptation system 505, vehicles 102a-102n and/or vehicles 200, objects 104a-104n, routes 106a-106n, area 108, vehicle-to-infrastructure (V2I) device 110, network 112, remote autonomous vehicle (AV) system 114, fleet management system 116, and/or V2I system 118. In some embodiments, domain adaptation system 505 includes, forms a part of, is coupled to, and/or uses vehicles 102a-102n and/or vehicles 200, objects 104a-104n, routes 106a-106n, area 108, vehicle-to-infrastructure (V2I) device 110, network 112, remote autonomous vehicle (AV) system 114, fleet management system 116, and/or V2I system 118.

FIG. 5 is a diagram of an implementation of a process for unsupervised domain adaptation for LiDAR segmentation via enhanced pseudo-labeling techniques. Domain adaptation can include updating a machine learning model trained to generate correct semantic labels for a source domain to also generate correct semantic labels for a target domain. Domain adaptation can be applied to train machine learning models with regard to object, location, temporal, environmental adaptations. Unsupervised domain adaptation may include the transfer of useful knowledge from a source domain having annotated training data (e.g., LiDAR samples from the source domain with pointwise ground-truth semantic labels) to a target domain without annotated training data. This transfer of useful knowledge may include applying the machine learning model to generate pseudo labels that bridge disparate domain data and to improve adaptation of the machine learning model. For example, in some embodiments, a machine learning model (e.g., a neural network and/or the like) trained to generate correct semantic labels for a source domain (e.g., a first location, a first time of the day, a first weather condition, and/or the like) may be applied to generate pseudo-labels for unannotated samples associated with a target domain (e.g., a second location, a second time of the day, a second weather condition, and/or the like). At least a portion of the pseudo-labeled samples from the target domain may be concatenated with ground-truth labeled samples from the source domain to generate a training set for adapting the domain of the machine learning model from the source domain to the target domain.

As shown in FIG. 5, in some embodiments, the implementation 500 can include a domain adaptation system 505 configured to provide data 515 to a localization system 406. For example, the data 515 can include LiDAR data associated with at least one point cloud or a combined point cloud generated by one or more LiDAR sensors, such as LiDAR sensors 202b. The data 515 can include labeled point cloud data that is determined via the domain adaptation network 510 for a target domain based on training data associated with a source domain and the target domain. The data 515 can thus include pseudo-labeled point cloud data 515 classified to describe one or more objects or elements present within the target domain.

FIG. 6 is a diagram of an implementation of a process for unsupervised domain adaptation for LiDAR segmentation via enhanced pseudo-labeling techniques. As shown in FIG. 6, in some embodiments, implementation 500 can be provided via a domain adaptation system 505 including a domain adaptation network 510 configured to generate pseudo-labeled point cloud data 515 for a target domain. Source data 520 (e.g. LiDAR point cloud data) from a source domain (e.g., a first location) and target data 525 (e.g. LiDAR point cloud data) from a target domain (e.g., a second location) can be received. A domain gap may exist between the source domain and the target domain. The domain gap can be associated with a discrepancy domain specific knowledge between the two domains, such as a discrepancy in physical location, characteristics of different weather conditions, or day-night variations. Examples of discrepancies in physical locations between the source domain and the target domain can include discrepancies such as road materials, street scenes, population density, transportation vehicle types, or the like.

The source data 520 may include samples (e.g., LiDAR samples) that have been annotated with ground-truth sematic labels to generate labeled source data 530. Contrastingly, the target data 525 does not include any ground-truth semantic labels. Training a machine learning model 555 (e.g., a neural network) in a supervised manner typically includes adjusting, for each training sample, the weights applied by the machine learning model 555 to minimize an error between the output of the machine learning model 555 and the ground-truth label associated with the training sample. As such, absent ground-truth semantic labels for the target data 525, the machine learning model 555 (e.g., a neural network) may not be trained in a supervised manner (e.g., through backwards propagation of error) at least because it is not possible to compute the segmentation loss by measuring the distance between the output of the machine learning model 555 and the corresponding ground-truth labels. To address this shortcoming, the domain adaptation network 510 can include a pseudo-label generator 535 configured to generate pseudo-labels for the target domain data 525 with class-wise confidence thresholds determined via anti-aliasing filters. Additionally, the domain adaptation network can include an entropy aggregator 540 configured to iteratively apply an easy-to-hard confidence ranking strategy. Outputs of the entropy aggregator 540 can include confidently pseudo-labeled target data 545A and less confidently pseudo-labeled target data 545B.

The domain network 510 can further include a first instantiation of a domain concatenator 550A can be configured to mix the labeled source data 530 and the confidently pseudo-labeled target data 545A by applying one or more concatenation strategies. Training of the machine learning model 555 (e.g., a neural network) can be performed using the mix of concatenated labeled source data 530 and confidently pseudo-labeled target data 545A output by the domain concatenator 550A. Iteratively refining 560 the model 550 can be performed to generate a retrained machine learning model 565. The retrained model 565 can be configured to generate the pseudo-labeled point cloud data 515 based on concatenated inputs of the less confidently pseudo-labeled target data 545B that can be generated by a second instantiation of a domain concatenator 550B configured to apply the one or more concatenation strategies to the less confidently pseudo-labeled target data 545B.

In the context of UDA for LiDAR segmentation, samples from the labeled source domain and unlabeled target domain can be presented as shown in equation 1:

[symbol]

ₛ={aₛⁱ,yₛⁱ}ᵢ₌₁^{M} and [symbol] ₜ={aₜ^{j}}ⱼ₌₁^{N}, (1)

where M and N are the total number of source and target samples. For segmentation with C classes, the network G can be optimized in a supervised way with source samples by minimizing the cross-entropy loss as follows shown in equation 2:

$${min}_{w} {ℒ}_{s} = - \frac{1}{\vert M \vert} {\sum }_{{a}_{s} ∈ M} {\sum }_{c = 1}^{C} {y}_{s}^{( c )} log p ( c \vert {a}_{s} , w ) , \qquad ( 2 )$$

where w denotes the weights of G; p(⋅) is the probability of class c in the softmax output. Due to the lack of ground-truth in the target domain, the target labels can be hidden variables and the most confident target predictions on the existing model can be selected as one-hot “pseudo-labels” y\hat{ }ₜ. The learning objective for the target domain can be expressed as in equation 3:

$${min}_{w} {ℒ}_{t} = - \frac{1}{\vert N \vert} {\sum }_{{a}_{t} ∈ N} {\sum }_{c = 1}^{C} {\hat{y}}_{t}^{( c )} log p ( c \vert {a}_{t} , w ) , \\ s . t . {\hat{y}}_{t} = \{ \begin{matrix}arg {max}_{c} p ( c \vert {a}_{t} , w ) , & if max ( p ( c \vert {a}_{t} , w ) ) \geq θ \\ ignored , & otherwise\end{matrix} \qquad ( 3 )$$

where θ is a threshold for filtering non-confident pseudo-labels. A proportion parameter k can be set to determine the class-wise thresholds θ_{c} for each class c to balance the class distributions.

Given a source batch {aₛ, yₛ} and a target batch {aₜ, y\hat{ }ₜ}, an intermediate domain construction mechanism M(⋅) can follow three steps. First, a template can be defined for the total number of segregation regions along the near-far dimension (m) in the RV projections and around the ego-vehicle (n). An example of a domain concatenation with m=2 and n=2, can include having front-near, front-far, back-near, and back-far regions, respectively. Second, regions can be sliced based on the above template for every sample in both batches. This gives ((bₛ+bₜ)×m×n) sliced stripes, where bₛ and bₜ are the batch sizes. Third, the stripes can be concatenated while keeping their spatial locations consistent, resulting in (bₛ+bₜ) intermediate domain samples an. Their labels y_{π} can be obtained via the same arrangement of the original labels and pseudo-labels. The segmentation loss Lπ for this intermediate domain can be computed using the mixed batch {a_{π}, y_{π}}. The overall objective for self-training is to minimize the following shown in equation 4:

[symbol]

= [symbol] ₛ(w,yₛ)+σ· [symbol] _{π}(w,y_{π}), (4)

where σ is a coefficient that controls the probability of accessing the intermediate domain.

This concatenation approach can mix objects and background from both domains, while still preserving the overall consistency. This stability in semantic coherence comes from the priors that the LiDAR point clouds are unstructured and extremely sparse even after RV projections.

Seeing improved generalizability removing aliasing artifacts in the convolutional networks, an anti-aliasing regularizer can be provided within each convolution filter in the segmentation network to reduce learning from aliasing artifacts. This can impose regularization on high-frequency representation learning since they are more susceptible to aliasing artifacts. We achieve this via fc,r=fr□fc, where fr denotes a regularizer which is consists of learnable parameters having the same size as the convolution filter fc; fc,r can be the regularized filter kernel of each convolution; □denotes the Hadamard multiplication. During the earlier stages of training, the network can learn low-frequency representations that are robust to aliasing artifacts. This will thereby update fr such that it becomes more suited for low-frequency representation learning of fc,r.

In later phases of training or UDA self-training, however, the network is more inclined to learn increasingly higher frequency representations and thus becomes more susceptible to aliasing artifacts. The modulation of fr on fc regularizes gradient updates corresponding to these high-frequency representations and in particular, regularizes the ones that are considerably different from the earlier network learning. This implicit regularization mechanism at later stages of training makes fc,r more resistant to high-frequency aliasing artifacts than the plain convolution filter fc. Note that, since fc and fr are both constants during inference, the regularized filter kernel fc,r only needs to be computed once at the end of training and then can be used at inference without adding any additional computational cost or structural changes to the network.

As pseudo-labels generated from the source pre-trained model tend to be noisy, an entropy aggregator is provided to disable the access of non-confident target predictions and thus improve the overall quality of the intermediate domain supervisions. Given a target sample at, its entropy map E composed of the normalized pixel-wise entropies can be calculated as follows in equation 5:

$$ℰ = \frac{- 1}{log ( C )} {\sum }_{c = 1}^{C} p ( c \vert {a}_{t} , w ) log p ( c \vert {a}_{t} , w ) . \qquad ( 5 )$$

The median value e ω of ε for each at is used as the global-level indicator of uncertainty, which is more robust than the average value due to the large “noisy” predictions for the empty RV cells. The target set Aₜ={aₜ^{j}}ⱼ₌₁^{N} is reorganized based on e and only the top most confident target samples are included as the supervisions for the intermediate domain.

An exemplary training procedure can include two rounds of self-training that encourage fine-grained interactive learning in-between domains while regularizing anti-aliasing artifacts and non-confident target predictions. As shown in procedure A, in some embodiments, the training procedure can include:

```
  1: Input: Source data {aₛ, yₛ}; target data {aₜ}; pre-
    trained backbone weights w̅^{r0}; parameters ω, k, σ
  2: Output: Self-trained backbone weights w^{r2}
  3: Round 1:
  4: Calculate e = mid(ε) for all aₜ with w^{r0}
  5: Sort {aₜ} in an ascending order based on e
  6: Keep the top ω̅ {aₜ} and discard the rest → {aₜ}_{ω}
  7: Generate pseudo-labels {ŷₜ}_{ω} with k, w^{r0}
  8: repeat
  9: {a_{π}^{r1}, y_{π}^{r1}} = [symbol]   ({aₛ, yₛ}, {aₜ, ŷₜ}_̅{̅ω̅}̅)
10: Calculate loss [symbol]   with σ; update weights
11: until convergence → w^{r1}
12: Round 2:
13: Generate pseudo-labels {ŷₜ} with k, w^{r1}
14: repeat
15: {a_{π}^{r2}, y_{π}^{r2}} = [symbol]   ({aₛ, yₛ}, {aₜ, ŷₜ})
16: Calculate loss [symbol]   with σ; update weights
17: until convergence → w^{r2}
```

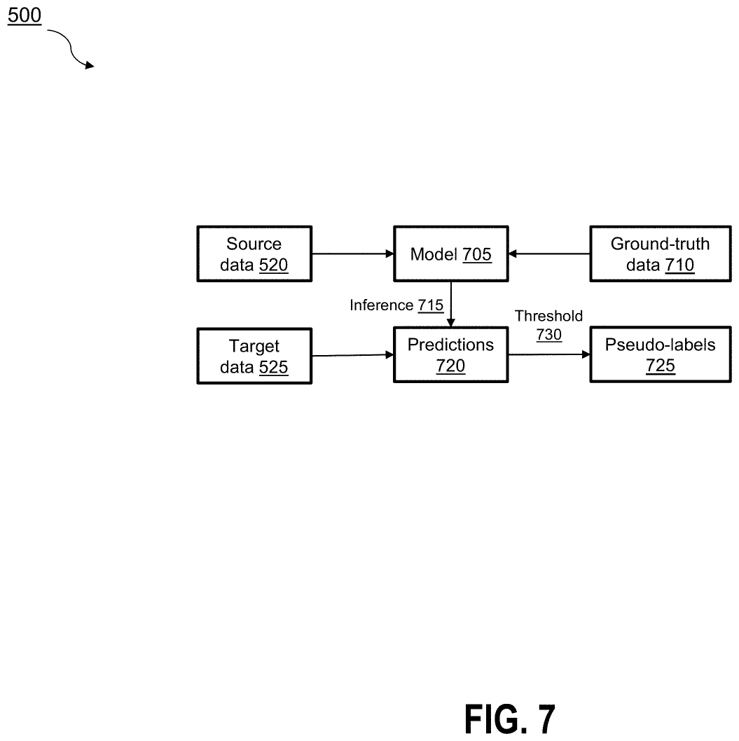

FIG. 7 is a diagram of an overview of enhanced pseudo-labeling techniques for use in unsupervised domain adaptation for LiDAR segmentation. As shown in FIG. 7, the implementation 500 can generate pseudo labels 725 by training the model 705 with the source data 520 and corresponding ground-truth data 710. In some embodiments, the model 705 can be the same as model 555 described in relation to FIG. 6. Once trained, the model 705 can be used for inference 715 to generate predictions 720 for every point in LiDAR point cloud data that is received as the target data 525. To account for the domain discrepancies between the source data 520 and the target data 525, a threshold 730 can be applied to the predictions 715. In this way, only the most confident predictions 720 are selected as pseudo-labels 725. In some embodiments, the threshold 730 can include class-wise confidence thresholds for each semantic category or class of sensed object. In some embodiments, the class-wise thresholds can be applied based on a number of points for each class, rather than setting a fixed threshold for each class. In this way, pseudo-label generation can be performed without bias for classes with large numbers of points.

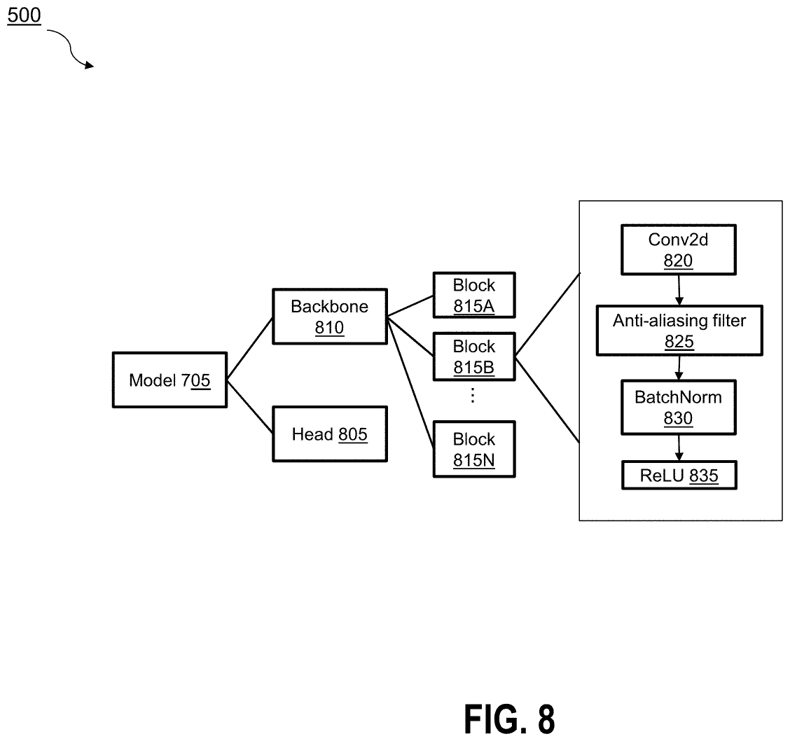

FIG. 8 is a diagram of an implementation of a process for enhanced pseudo-labeling techniques for use in unsupervised domain adaptation for LiDAR segmentation. As shown in FIG. 8, the implementation 500 can generate pseudo-labels using an anti-aliasing filter 825 provided in the backbone 805 of the model 705. In some embodiments, the model 705 can be the same as model 555 described in relation to FIG. 6. The model 705 can include a head 805 and a backbone 810 configured as several blocks 815 (e.g., blocks 815A, 815B, . . . 815N). Each block 815 can include one or more modules, such as a Conv2d module 820 implementing a 2D convolution layer, a BatchNorm module 830 implementing a batch normalization layer, and a ReLu module 835 implementing a rectifier activation function. To prevent the model 805 from learning corrupted features during sub-sampling, an anti-aliasing filter 825 is added into each of the blocks 815. The anti-aliasing filter 825 can make the model 705 more generalizable and robust when generating pseudo-labels without added computational cost for inferencing. For example, the anti-aliasing filter may be a low-pass filter that removes high-frequency components from the input. Application of the anti-aliasing filter may render the machine learning model 555 more shift invariant, meaning that small shifts in the input (e.g., noise) do not produce significant changes in the output of the machine learning model 555.

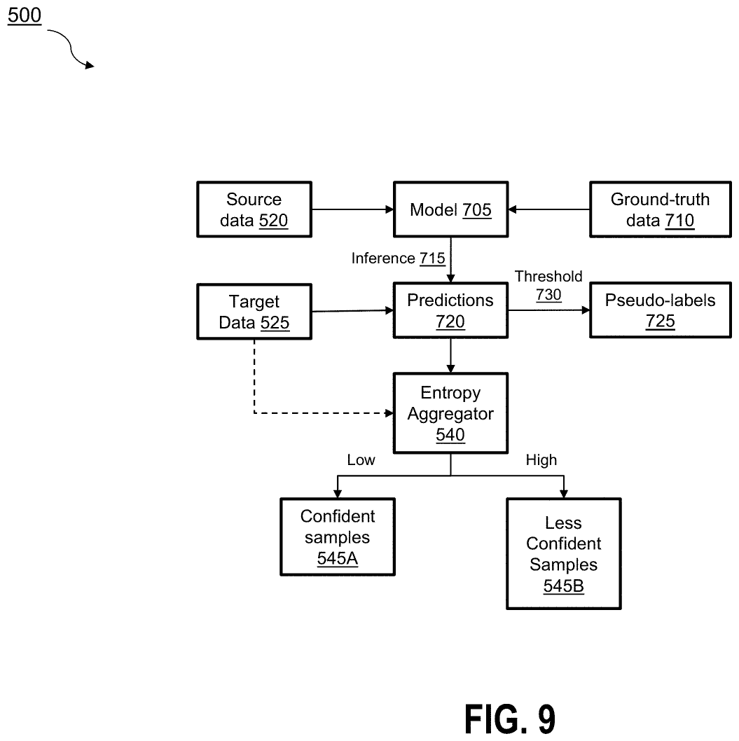

FIG. 9 is a diagram of an overview of entropy ranking techniques used in pseudo-label generation applied to unsupervised domain adaptation for LiDAR segmentation. As shown in FIG. 9, the implementation 500 of FIG. 7 is illustrated and further includes an entropy aggregator 540 described in relation to FIG. 6. The entropy aggregator 540 can be configured to split samples of the target data 525 into sample sets 545A and 545B based on whether the machine learning model 555 is able to assign a semantic label with sufficiently high confidence or low entropy (e.g., cross-entropy). In some cases, to determine the confidence measures and corresponding sample sets, entropy values can be determined for the predictions 720. In one example scenario where the machine learning model 555 is trained to assign a sample one of two possible semantic labels, the entropy associated with the output of the machine learning model 555 may correspond to a first probability of a first semantic label and a second probability of a second semantic label. Where the probability distribution is balanced (e.g., high entropy), the first probability and the second probability may indicate an equal (or near equal) likelihood that the sample is associated with the first semantic label and the second semantic label. Contrastingly, where the probability distribution is skewed (e.g., low entropy), the first probability and the second probability may indicate a much higher likelihood that the sample is associated with one of the first semantic label and the second semantic label than the other.

Once the entropy values have been determined for all samples of the target data 525, the samples can be ranked based on their entropy values. Samples 545A having low entropy values can correspond to prediction samples 720 that are confident (or more probable to accurately reflect a ground truth associated with the sample). Samples 5454B having high entropy values can corresponds to prediction samples 720 that are less confident. The pseudo-labels 725 can thus be labeled accordingly to align with the determined entropy values.

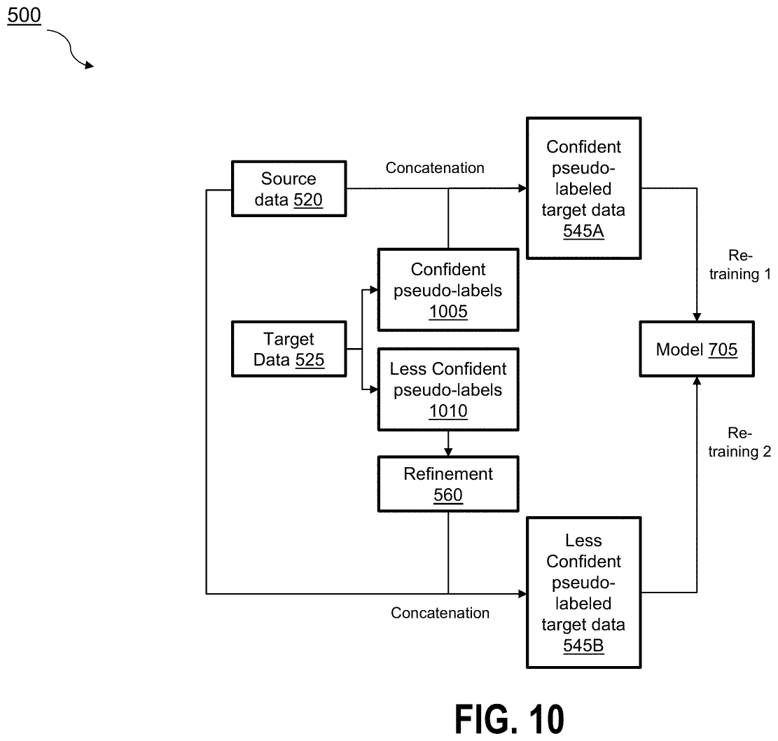

FIG. 10 is a diagram of an implementation of a process for entropy ranking techniques used in pseudo-label generation applied to unsupervised domain adaptation for LiDAR segmentation. As shown in FIG. 10, the implementation 500 of FIG. 5 is illustrated and further includes a process for performing domain concatenation via instantiations of the domain concatenator 550A and 550B described in relation to FIG. 5.

As shown in FIG. 10, the implementation 500 after splitting the target data 525 into samples of confident pseudo-labels 1005 and less confident pseudo-labels 1010, additional training of the model 705 can performed. For example, in a first round of re-training (e.g., Re-training 1), the source data 520 can be concatenated with the samples of the confident pseudo-labels 1005 to be used as domain mixed data (e.g., confident pseudo-labeled target data 545A) for training model 705. In a second round of retraining (e.g., Re-training 2), target data 525 associated with samples of the confident pseudo-labels 1005 and the less confident pseudo-labels 1010 can be concatenated and used to retrain the model 705. Samples associated with the less confident pseudo-labels 1010 are provided to a refinement module 560 to improve the confidence of the samples via neighboring confident pseudo-labels and via an ensemble of models used before training and after training.

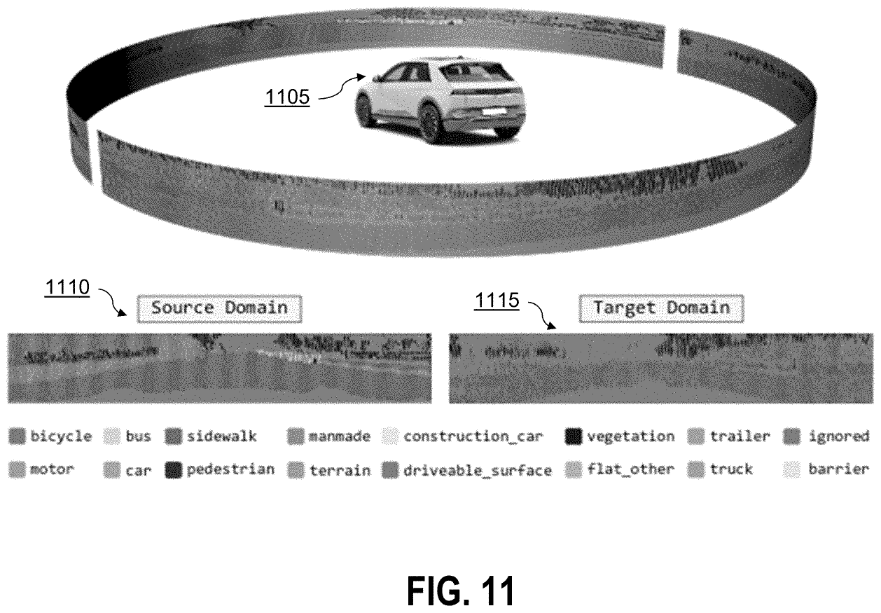

FIG. 11 is a diagram of domain concatenation data used in unsupervised domain adaptation for LiDAR segmentation via enhanced pseudo-labeling techniques. As shown in FIG. 11, an example of domain concatenation associated with range view data is shown. The vehicle 1105 can obtain the range view data in operation and provide to the domain adaptation system 505. The domain adaptation system 505 can generate source domain data 1110 and target domain data 1115 based on the range view data. The source domain data 1110 and target domain data 1115 can be sliced into stripes and concatenated together at corresponding pixel locations. In this way, the domain adaptation system 505 can continuously utilize half of the ground truth labels associated with the source domain data 1110 to guide the domain adaptation processes described herein.

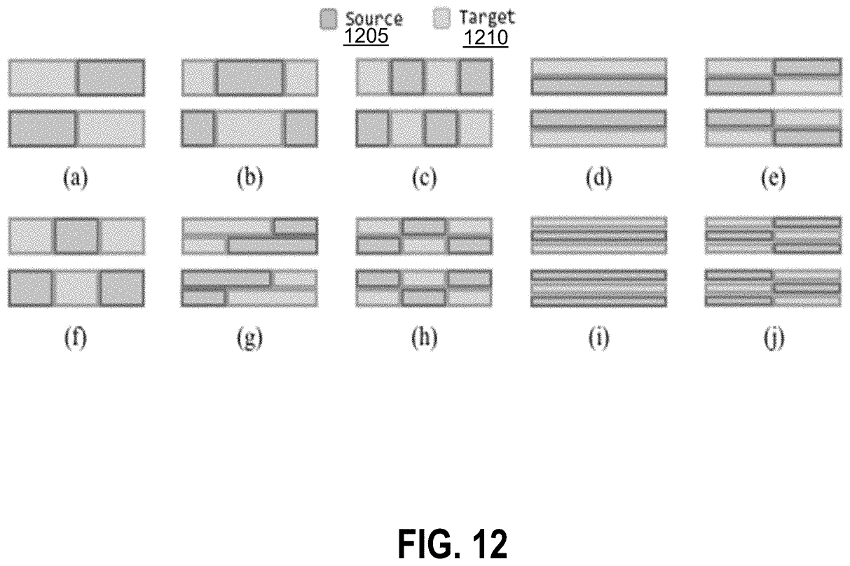

FIG. 12 is a diagram of domain concatenation strategies used in unsupervised domain adaptation for LiDAR segmentation via enhanced pseudo-labeling techniques. As shown in FIG. 12, the domain adaptation system 505 can be configured to implement a variety of concatenation strategies via instantiations of the domain concatenators 550 described in relation to FIG. 5. For example, different embodiments of concatenation strategies (a)-(j) can include slicing the source domain data 1205 and target domain data 1210 into stripes in a variety of non-limiting arrangements shown in FIG. 12. Advantageously, the concatenation strategies implemented in the domain adaptation system 505 described herein can provide more precise and fine-grained interactions between source domain data and target domain data.

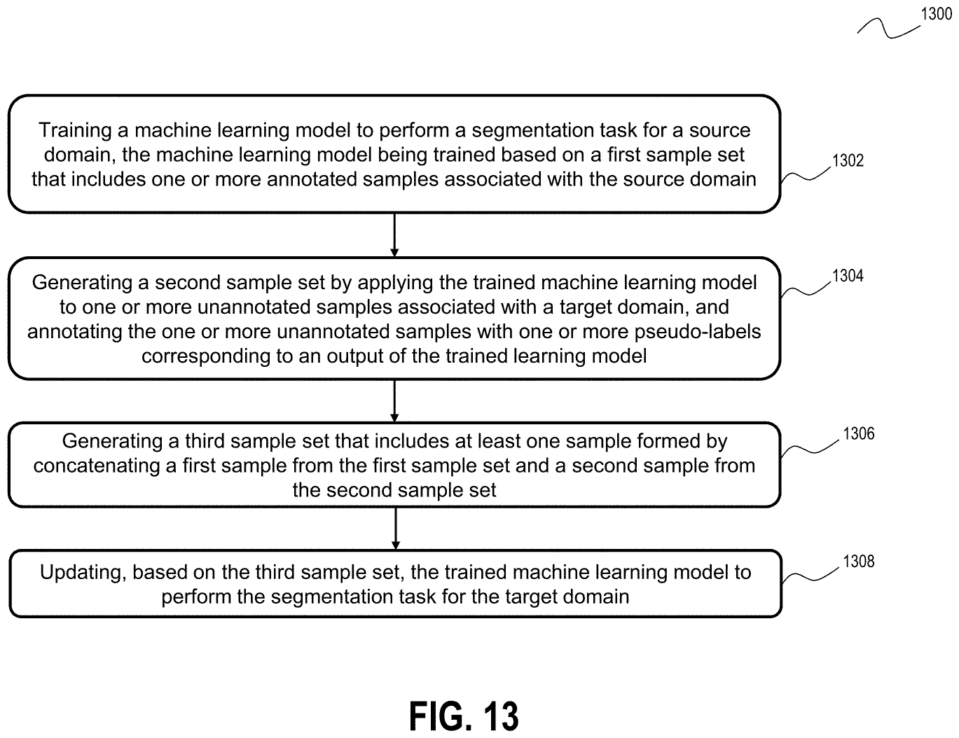

Referring now to FIG. 13, illustrated is a flowchart of a process 1300 for unsupervised domain adaptation for LiDAR segmentation via enhanced pseudo-labeling techniques. In some embodiments, one or more of the steps described with respect to process 1300 are performed (e.g., completely, partially, and/or the like) by domain adaptation system 505. Additionally, or alternatively, in some embodiments one or more steps described with respect to process 800 are performed (e.g., completely, partially, and/or the like) by another device or group of devices separate from or including domain adaptation system 505.

At 1302, a machine learning model (e.g., a neural network) is trained, using at least one processor, to perform a segmentation task (e.g., LiDAR segmentation) for a source domain, the machine learning model being trained based on a first sample set that includes one or more annotated samples associated with the source domain (e.g., source inputs with ground-truth labels). In some embodiments, the source domain and the target domain can include at least one of different geographical locations (e.g., location-to-location adaptation), different times of the day (e.g, day-to-night adaptation), and different weather (e.g., weather-to-weather adaptation).

In some embodiments, the segmentation task can include a LiDAR segmentation in which the machine learning model assigns a semantic label to one or more points in a LiDAR point cloud (e.g., LiDAR segmentation can include assigning the semantic label for each point in a LiDAR point cloud). In some embodiments, the semantic label can identify at least one of a physical feature or an object corresponding to the one or more points (e.g., bicycle, bus, sidewalk, manmade, construction car, vegetation, trailer, motor, car, pedestrian, terrain, drivable surface, flat, truck barrier).

At 1304, a second sample set is generated, using the at least one processor, by applying the trained machine learning model to one or more unannotated samples associated with a target domain (e.g., target inputs without ground-truth labels), and annotating the one or more unannotated samples with one or more pseudo-labels corresponding to an output of the trained machine learning model (e.g., generating pseudo-labels for the target domain).

At 1306, a third sample set is generated, using the at least one processor. The third sample set includes at least one sample formed by concatenating a first sample from the first sample set and a second sample from the second sample set (e.g., mixing domains by concatenating the source inputs (without ground-truth labels) with target inputs (without ground-truth labels)). In some embodiments, the third sample set can be generated to include the second sample from the second sample set based at least on a first confidence of a first label assigned to the second sample by the trained machine learning model satisfying a threshold (e.g., during an initial training phase, the source data can be concatenated with the confident target data to form domain mixed data for the training). In some embodiments, the output of the trained machine learning model comprises a probability distribution across a plurality of labels, and wherein the first confidence of the first label corresponds to an entropy of the probability distribution (e.g., due to the domain discrepancy, the most confident predictions can be selected as the pseudo-labels).

In some embodiments, the threshold can be determined based on a quantity of samples included in the first sample set having the first label (e.g., rather than setting a fixed threshold for every class, class-wise thresholds can be set based on the number of points for each class to prevent the pseudo-label generation from being biased towards those classes with large amount of points).

In some embodiments, the third sample can be formed by stitching together the first sample and the second sample. In some embodiments, the third sample can be formed by stitching together alternating portions of the first sample and the second sample. In some embodiments, the machine learning model can include a neural network.

In some embodiments, the machine learning model can include an anti-aliasing filter configured to suppress high frequency components present in an input of the machine learning model. In some embodiments, the anti-aliasing filter can include a low-pass filter that is applied prior to downsampling the input (e.g., to prevent the machine learning model from learning corrupted features during subsampling, the anti-aliasing filters can be added into portions of the machine learning model).

At 1308, the trained machine learning model is updated, using the at least one processor and based on the third sample set, to perform the segmentation task for the target domain (e.g., location-to-location adaptation, day-to-night adaptation, weather-to-weather adaptation).

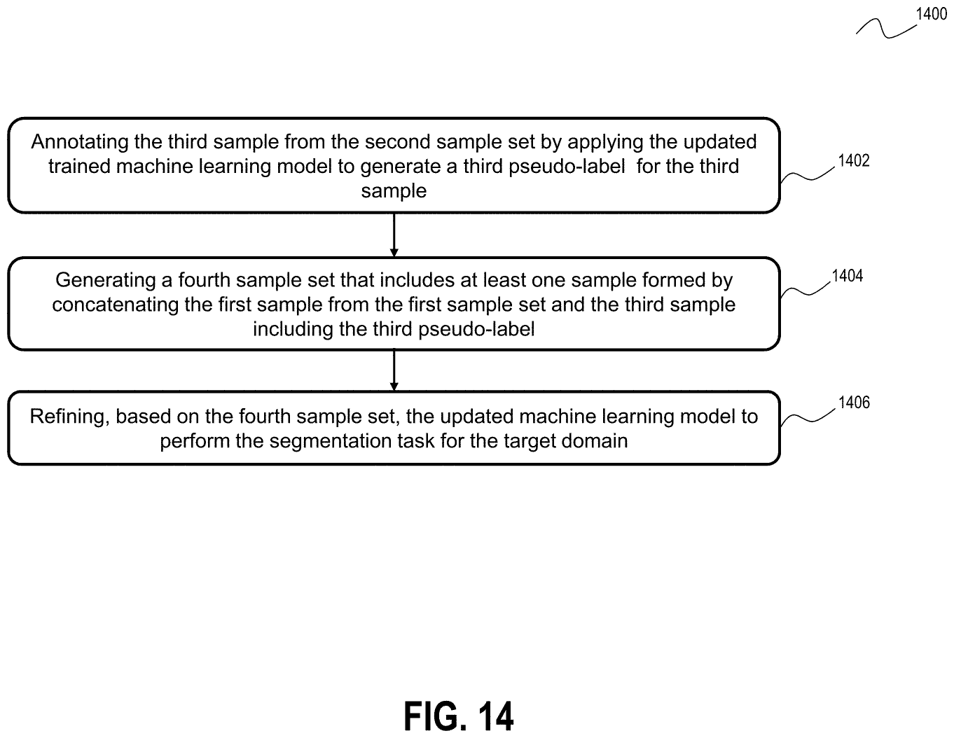

Referring now to FIG. 14, illustrated is a flowchart of a process 1400 for unsupervised domain adaptation for LiDAR segmentation using source data concatenation based on confidence determination techniques. In some embodiments, one or more of the steps described with respect to process 1400 are performed (e.g., completely, partially, and/or the like) by domain adaptation system 505. Additionally, or alternatively, in some embodiments one or more steps described with respect to process 1400 are performed (e.g., completely, partially, and/or the like) by another device or group of devices separate from or including domain adaptation system 505. In some embodiments, the third sample set (e.g., generated at 1306) can exclude a third sample from the second sample set based at least on a second confidence of a second label assigned to the third sample by the trained machine learning model failing to satisfy the threshold. As a result, domain concatenation and additional training can be performed to refine the machine learning model.

For example, at 1402, the third sample from the second sample set can be annotated by applying the updated trained machine learning model to generate a third pseudo-label for the third sample.

At 1406, a fourth sample set that includes at least one sample formed by concatenating the first sample from the first sample set and the third sample including the third pseudo-label can be generated.

At 1408, the updated machine learning model can be refined, based on the fourth sample set, to perform the segmentation task for the target domain.

The unsupervised domain adaptation for LiDAR segmentation using enhanced pseudo-labeling techniques described herein can provide technical solutions, which can provide technical advantages over existing domain adaptation systems. The advantages can include, but are not limited to, increased labeling and domain adaptation performance of machine learning models for a variety of different types of domain discrepancies. For example, location-to-location adaptations, temporal (e.g., day-to-night) adaptations, class or object type adaptations, as well as weather-related adaptations. In addition, the unsupervised domain adaptation techniques using enhanced pseudo-labeling described herein can be generally applies for different kinds of range-view projection-based segmentation networks and may not be limited to LiDAR segmentation networks. Further, the unsupervised domain adaptation techniques using enhanced pseudo-labeling described herein can aid initialization, boot-strapping, or start-up configuration of semantic annotation processes to achieve better segmentation results more quickly compared to existing domain adaptation systems. In this way, new domain adaptation systems configured as described herein can be deployed rapidly an new domains with reduced model training times.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
training, using at least one processor, a machine learning model to perform a segmentation task for a source domain, the machine learning model being trained based on a first sample set that includes one or more annotated samples associated with the source domain;
generating, using the at least one processor, a second sample set by applying the trained machine learning model to one or more unannotated samples associated with a target domain, and annotating the one or more unannotated samples with one or more pseudo-labels corresponding to an output of the trained machine learning model;
generating, using the at least one processor, a third sample set that includes at least one sample formed by concatenating a first sample from the first sample set and a second sample from the second sample set; and
updating, using the at least one processor and based on the third sample set, the trained machine learning model to perform the segmentation task for the target domain.

2. The method of claim 1, wherein the third sample set is generated to include the second sample from the second sample set based at least on a first confidence of a first label assigned to the second sample by the trained machine learning model satisfying a threshold.

3. The method of claim 2, wherein the output of the trained machine learning model comprises a probability distribution across a plurality of labels, and wherein the first confidence of the first label corresponds to an entropy of the probability distribution.

4. The method of claim 2, wherein the third sample set excludes a third sample from the second sample set based at least on a second confidence of a second label assigned to the third sample by the trained machine learning model failing to satisfy the threshold.

5. The method of claim 4, further comprising:
annotating, using the at least one processor, the third sample from the second sample set by applying the updated trained machine learning model to generate a third pseudo-label for the third sample;
generating, using the at least one processor, a fourth sample set that includes at least one sample formed by concatenating the first sample from the first sample set and the third sample including the third pseudo-label; and
refining, using the at least one processor and based on the fourth sample set, the updated machine learning model to perform the segmentation task for the target domain.

6. The method of claim 2, wherein the threshold is determined based on a quantity of samples included in the first sample set having the first label.

7. The method of claim 1, wherein the third sample is formed by stitching together the first sample and the second sample.

8. The method of claim 1, wherein the third sample is formed by stitching together alternating portions of the first sample and the second sample.

9. The method of claim 1, wherein the machine learning model comprises a neural network.

10. The method of claim 1, wherein the machine learning model includes an anti-aliasing filter configured to suppress high frequency components present in an input of the machine learning model.

11. The method of claim 10, wherein the anti-aliasing filter comprises a low-pass filter that is applied prior to downsampling the input.

12. The method of claim 1, wherein the source domain and the target domain comprise at least one of different geographical locations.

13. The method of claim 1, wherein the segmentation task comprises a LiDAR segmentation in which the machine learning model assigns a semantic label to one or more points in a LiDAR point cloud.

14. The method of claim 13, wherein the semantic label identifies at least one of a physical feature or an object corresponding to the one or more points.

15. A system, comprising:
at least one processor, and
at least one non-transitory storage media storing instructions that, when executed by the at least one processor, cause the at least one processor to:
train, using at least one processor, a machine learning model to perform a segmentation task for a source domain, the machine learning model being trained based on a first sample set that includes one or more annotated samples associated with the source domain;
generate, using the at least one processor, a second sample set by applying the trained machine learning model to one or more unannotated samples associated with a target domain, and annotating the one or more unannotated samples with one or more pseudo-labels corresponding to an output of the trained machine learning model;
generate, using the at least one processor, a third sample set that includes at least one sample formed by concatenating a first sample from the first sample set and a second sample from the second sample set; and
update, using the at least one processor and based on the third sample set, the trained machine learning model to perform the segmentation task for the target domain.

16. The system of claim 15, wherein the third sample set is generated to include the second sample from the second sample set based at least on a first confidence of a first label assigned to the second sample by the trained machine learning model satisfying a threshold.

17. The system of claim 16, wherein the output of the trained machine learning model comprises a probability distribution across a plurality of labels, and wherein the first confidence of the first label corresponds to an entropy of the probability distribution.

18. The system of claim 16, wherein the third sample set excludes a third sample from the second sample set based at least on a second confidence of a second label assigned to the third sample by the trained machine learning model failing to satisfy the threshold.

19. The system of claim 18, wherein the at least one processor is further configured to:
annotate, using the at least one processor, the third sample from the second sample set by applying the updated trained learning model to generate a third pseudo-label for the third sample;
generate, using the at least one processor, a fourth sample set that includes at least one sample formed by concatenating the first sample from the first sample set and the third sample including the third pseudo-label; and
refine, using the at least one processor and based on the fourth sample set, the updated machine learning model to perform the segmentation task for the target domain.

20. The system of claim 16, wherein the threshold is determined based on a quantity of samples included in the first sample set having the first label.

21. The system of claim 15, wherein the third sample is formed by stitching together the first sample and the second sample.

22. The system of claim 15, wherein the third sample is formed by stitching together alternating portions of the first sample and the second sample.

23. The system of claim 15, wherein the machine learning model comprises a neural network.

24. The system of claim 15, wherein the machine learning model includes an anti-aliasing filter configured to suppress high frequency components present in an input of the machine learning model.

25. The system of claim 24, wherein the anti-aliasing filter comprises a low-pass filter that is applied prior to downsampling the input (e.g., to prevent the network from learning corrupted features during subsampling, we add in the anti-aliasing filters into the blocks).

26. The system of claim 15, wherein the source domain and the target domain comprise at least one of different geographical locations, different times of the day, and different weather.

27. The system of claim 15, wherein the segmentation task comprises a LiDAR segmentation in which the machine learning model assigns a semantic label to one or more points in a LiDAR point cloud.

28. The system of claim 27, wherein the semantic label identifies at least one of a physical feature or an object corresponding to the one or more points.

29. At least one non-transitory storage media storing instructions that, when executed by at least one processor, cause the at least one processor to:
train, using at least one processor, a machine learning model to perform a segmentation task for a source domain, the machine learning model being trained based on a first sample set that includes one or more annotated samples associated with the source domain;
generate, using the at least one processor, a second sample set by applying the trained machine learning model to one or more unannotated samples associated with a target domain, and annotating the one or more unannotated samples with one or more pseudo-labels corresponding to an output of the trained machine learning model;
generate, using the at least one processor, a third sample set that includes at least one sample formed by concatenating a first sample from the first sample set and a second sample from the second sample set; and
update, using the at least one processor and based on the third sample set, the trained machine learning model to perform the segmentation task for the target domain.

30. The at least one non-transitory storage media of claim 29, wherein the third sample set is generated to include the second sample from the second sample set based at least on a first confidence of a first label assigned to the second sample by the trained machine learning model satisfying a threshold.

31. The at least one non-transitory storage media of claim 30, wherein the output of the trained machine learning model comprises a probability distribution across a plurality of labels, and wherein the first confidence of the first label corresponds to an entropy of the probability distribution.

32. The at least one non-transitory storage media of claim 30, wherein the third sample set excludes a third sample from the second sample set based at least on a second confidence of a second label assigned to the third sample by the trained machine learning model failing to satisfy the threshold.

33. The at least one non-transitory storage media of claim 32, wherein the instructions that cause the at least one processor to:
annotate, using the at least one processor, the third sample from the second sample set by applying the updated trained learning model to generate a third pseudo-label for the third sample;
generate, using the at least one processor, a fourth sample set that includes at least one sample formed by concatenating the first sample from the first sample set and the third sample including the third pseudo-label; and
refine, using the at least one processor and based on the fourth sample set, the updated machine learning model to perform the segmentation task for the target domain.

34. The at least one non-transitory storage media of claim 30, wherein the threshold is determined based on a quantity of samples included in the first sample set having the first label.

35. The at least one non-transitory storage media of claim 29, wherein the third sample is formed by stitching together the first sample and the second sample.

36. The at least one non-transitory storage media of claim 29, wherein the third sample is formed by stitching together alternating portions of the first sample and the second sample.

37. The at least one non-transitory storage media of claim 29, wherein the machine learning model comprises a neural network.

38. The at least one non-transitory storage media of claim 29, wherein the machine learning model includes an anti-aliasing filter configured to suppress high frequency components present in an input of the machine learning model.

39. The at least one non-transitory storage media of claim 38, wherein the anti-aliasing filter comprises a low-pass filter that is applied prior to downsampling the input.

40. The at least one non-transitory storage media of claim 29, wherein the source domain and the target domain comprise at least one of different geographical locations, different times of the day, and different weather.

41. The at least one non-transitory storage media of claim 29, wherein the segmentation task comprises a LiDAR segmentation in which the machine learning model assigns a semantic label to one or more points in a LiDAR point cloud.

42. The at least one non-transitory storage media of claim 29, wherein the semantic label identifies at least one of a physical feature or an object corresponding to the one or more points.
